(19) United States
(12) Patent Application Publication
(10) Pub. No.: US 2006/0140213 A1
(43) Pub. Date: Jun. 29, 2006

(54) Tunneling method and apparatus for multicasting between IPv4 network and IPv6 network

(76) Inventors: Sun-Young Hwang, Seoul (KR); Byung-Chang Kang, Yongin-si (KR); Yong-Seok Park, Yongin-si (KR)

Correspondence Address: Robert E. Bushnell, Suite 300, 1522 K Street, N.W., Washington, DC, 20005, US

(21) Appl. No.: 11/300,359

(22) Filed: Dec. 15, 2005

(30) Foreign Application Priority Data
Dec. 23, 2004 (KR) 2004-111397

(51) Int. Cl. H04L 12/56; H04J 3/26; H04J 3/16; H04L 12/28; H04J 3/22

(52) U.S. Cl. 370/466; 370/432; 370/390

(57) ABSTRACT

In a tunneling method and apparatus for multicasting between an IPv4 network and an IPv6 network, a multicast table containing information about receive and transmit interfaces in a multicast delivery tree structure for each of the IPv4 network and the IPv6 network is set, a multicast address area is assigned to the first network and a multicast address area is assigned to the second network compatible with the first network, an IPv6 multicast packet containing source and multicast destination addresses of the IPv6 network is received, and when a destination network of the IPv6 multicast packet is the IPv6 network connected to the IPv4 network, source and multicast destination addresses of the IPv4 network are extracted from source and multicast destination addresses contained in the IPv6 multicast packet, the IPv6 multicast packet is capsulated into an IPv4 format, and the IPv4 format packet is multicast-tunneled to the IPv6 network through the IPv4 network by referring to the multicast table.

### CLAIM OF PRIORITY

This application makes reference to, incorporates the same herein, and claims all benefits accruing under 35 U.S.C. §119 from an application for TUNNELING METHOD AND APPARATUS FOR MULTICASTING BETWEEN IPv4 NETWORK AND IPv6 NETWORK, filed in the Korean Intellectual Property Office on Dec. 23, 2004 and there duly assigned Serial No. 2004-111397.

### BACKGROUND OF THE INVENTION

1. Technical Field

The present invention relates to a tunneling method for multicasting, and more particularly, to a tunneling method and apparatus for capsulating an Internetworking Protocol, version 6 (IPv6) packet into an Internetworking Protocol, version 4 (IPv4) packet, and then tunneling the capsulated IPv4 packet to an IPv6 network through an IPv4 network in order to transmit the IPv6 packet to the IPv6 network through the IPv4 network.

2. Related Art

In transmission control protocol/Internetworking protocol (TCP/IP), which is an inter-network connection protocol, a network layer protocol is currently operated as Internetworking Protocol, version 4 (IPv4). IPv4 facilitates host-to-host communication between systems over the Internet. Even though IPv4 is said to be well designed, it is old (1970s) and no longer sufficient for data communication (via the Internet) which has continuously evolved.

To address this shortcoming, an Internet Protocol, version 6 (IPv6) known as “Internetworking Protocol, next generation (IPng)” has been proposed and standardized. Internet protocols in IPv6 have been significantly modified to accommodate the evolving Internet. For example, the format and length of an IP address were replaced with the format of a packet, and associated protocols (e.g., Internet control message protocol ICMP) were modified. In addition, other protocols, such as an address resolution protocol (ARP), a reverse address resolution protocol (RARP), and an Internet group management protocol (IGMP), were deleted from the network layer or included in the ICMP protocol. Furthermore, routing protocols (e.g., routing information protocol (RIP), open shortest path first (OSPF), etc.) were slightly modified.

At present, IPv6-based systems are being increasingly developed, but rapid transition from IPv4 to IPv6 is difficult due to the presence of a great number of systems on the Internet. That is, it takes much time for all of the systems on the Internet to transition from IPv4 to IPv6. In order to prevent problems from occurring between IPv4 systems and IPv6 systems, the transition should be gradual.

To ensure a smooth transition, strategies have been proposed by the Internet Engineering Task Force (IETF). These include a method with a dual stack, a header translation method, and a tunneling method.

In the method with the dual stack, all hosts have a dual stack protocol until complete transition to IPv6 is achieved. That is, IPv4 and IPv6 are simultaneously operated until all systems on the Internet use IPv6.

The header translation method is useful when most systems on the Internet use IPv6 and only some still use IPv4. When a sender wants to use IPv6 but a recipient cannot understand IPv6, the sender transmits an IPv6 packet whose header is translated into an IPv4 header.

The tunneling method is used when two computers using IPv6 have to pass through an area where IPv4 is used in order to communicate with each other. In this method, an IPv6 packet is capsulated into an IPv4 packet when entering the area where IPv4 is used, and decapsulated when leaving the IPv4 area. Among the three methods, the present invention is related to the tunneling method.

### SUMMARY OF THE INVENTION

It is an object of the present invention to provide a tunneling apparatus and method for multicasting between an IPv4 network and an IPv6 network, the method being capable of reducing data transmission load and increasing transmission efficiency when tunneling between IPv6 networks through an IPv4 network.

It is another object of the present invention to provide a tunneling method capable of multicasting between an IPv4 network and an IPv6 network using information on source and destination addresses in an IPv6 format contained in a multicast packet without requiring a separate table for address translation between the networks upon tunneling between IPv6 networks through the IPv4 network.

According to an embodiment of the present invention, there is provided a tunneling method for multicasting between different types of networks having different address formats, the method comprising the steps of: setting a multicast table containing information about receive and transmit interfaces in a multicast delivery tree structure for each of a first network having a first address format and a second network having a second address format, the second address format being different from the first address format; assigning a multicast address area to the first network and a multicast address area to the second network compatible with the first network; receiving a second network multicast packet containing source and multicast destination addresses in the second address format; and, when a destination network of the second network multicast packet is the second network connected to the first network, extracting source and multicast destination addresses in the first address format from the source and multicast destination addresses in the second address format, and multicast-tunneling the second network multicast packet to the second network through the first network by referring to the multicast table.

Preferably, the step of multicast-tunneling includes: capsulating the second network multicast packet into a first network multicast packet containing the extracted source and multicast destination addresses in the first address format to form a first capsulated network multicast packet; detecting, from the multicast table, a first network transmit interface for the first capsulated network multicast packet; and multicast-tunneling the first capsulated network multicast packet to the first network using the detected first network transmit interface.

The multicast tunneling method according to this embodiment preferably further includes the steps of: detecting, from the multicast table, a second network transmit interface for the second network multicast packet when a destination network of the second network multicast packet is the second network; and multicasting the second network multicast packet to the second network using the detected second network transmit interface.

According to another embodiment of the present invention, there is provided a tunneling method for multicasting between an IPv4 network and an IPv6 network, the method comprising the steps of: setting a multicast table containing information about receive and transmit interfaces in a multicast delivery tree structure for each of the IPv4 network and the IPv6 network; assigning a multicast address area to the IPv4 network and a multicast address area to the IPv6 network compatible with the IPv4 network; receiving an IPv6 multicast packet containing source and multicast destination addresses of the IPv6 network; and, when a destination network of the IPv6 multicast packet is the IPv6 network connected to the IPv4 network, extracting source and multicast destination addresses of the IPv4 network from the source and multicast destination addresses contained in the IPv6 multicast packet, capsulating the IPv6 multicast packet into an IPv4 format to form an IPv4 format packet, and multicast-tunneling the IPv4 format packet to the IPv6 network through the IPv4 network by referring to the multicast table.

Preferably, the step of multicast-tunneling includes the steps of: capsulating the IPv6 multicast packet into an IPv4 multicast packet containing the extracted source and multicast destination addresses of the IPv4 network to form a capsulated IPv4 multicast packet; detecting, from the multicast table, an IPv4 network transmit interface for the capsulated IPv4 multicast packet; and multicast-tunneling the capsulated IPv4 multicast packet to the IPv4 network using the detected IPv4 network transmit interface.

The multicast tunneling method according to this embodiment preferably includes the steps of: detecting, from the multicast table, an IPv6 transmit interface for the IPv6 multicast packet when a destination network of the IPv6 network multicast packet is the IPv6 network; and multicasting the IPv6 multicast packet to the IPv6 network using the detected IPv6 transmit interface.

Meanwhile, according to yet another embodiment of the present invention, there is provided a tunneling apparatus for multicasting between networks having different address formats, the apparatus comprising: a packet transmitter/receiver connected to a first network having a first address format and to a second network having a second address format for receiving and transmitting a packet, the second address format being different from the first address format; a multicast information manager for setting a multicast table containing information about receive and transmit interfaces in a multicast delivery tree structure for each of the first network and the second network; a capsulator/decapsulator for capsulating a packet received from the second network into a packet for the first network, and for decapsulating a packet received from the first network into a packet for the second network; and a multicast manager for assigning a multicast address area to the first network and a multicast address area to the second network compatible with the first network, for extracting source and multicast destination addresses in the first address format from source and multicast destination addresses in the second address format contained in a second network multicast packet for multicast-tunneling through the first network to the second network, and for multicast-tunneling the second network multicast packet to the second network through the first network by referring to the multicast table.

Preferably, the capsulator/decapsulator capsulates the second network multicast packet into a first network multicast packet containing the extracted source and multicast destination addresses in the first address format. The multicast manager preferably detects, from the multicast table, a first network transmit interface for the first capsulated network multicast packet, and multicast-tunnels the first capsulated network multicast packet to the first network using the first detected network transmit interface.

Furthermore, the multicast manager preferably detects, from the multicast table, a second network transmit interface for the second network multicast packet, and multicasts the second network multicast packet to the second network using the detected second network transmit interface when a destination network of the second network multicast packet is the second network.

According to yet another embodiment of the present invention, there is provided a tunneling apparatus for multicasting between an IPv4 network and an IPv6 network, the apparatus comprising: a packet transmitter/receiver connected to the IPv4 network and to the IPv6 network for receiving and transmitting a packet; a multicast information manager for setting a multicast table containing information about receive and transmit interfaces in a multicast delivery tree structure for each of the IPv4 network and the IPv6 network; a capsulator/decapsulator for capsulating a packet in an IPv6 network format into a packet in an IPv4 network format, and for decapsulating the capsulated packet in the IPv4 network format into the packet in the IPv6 network format; and a multicast manager for assigning a multicast address area to the IPv4 network and a multicast address area to the IPv6 network compatible with the IPv4 network, for extracting source and multicast destination addresses in an IPv4 address format from source and multicast destination addresses in an IPv6 address format contained in an IPv6 multicast packet for multicast-tunneling through the IPv4 network to the IPv6 network, and for multicast-tunneling the IPv6 network multicast packet to the IPv6 network through the IPv4 network by referring to the multicast table.

Preferably, the capsulator/decapsulator capsulates the IPv6 multicast packet into an IPv4 multicast packet containing the extracted source and multicast destination addresses in the IPv4 address format. The multicast manager preferably detects, from the multicast table, an IPv4 network transmit interface for the capsulated IPv4 network multicast packet, and multicast-tunnels the capsulated IPv4 network multicast packet to the IPv4 network using the detected IPv4 network transmit interface.

Furthermore, the multicast manager preferably detects, from the multicast table, an IPv4 network transmit interface for the IPv6 multicast packet, and multicasts the IPv6 multicast packet to the IPv6 network using the detected IPv6 network transmit interface when a destination network of the IPv6 multicast packet is the IPv6 network.

In the present invention, an IPv6 multicast address compatible with an IPv4 multicast address is utilized. The IPv4 multicast address is extracted from the IPv6 multicast address to capsulate an IPv6 multicast packet into an IPv4 multicast packet, and then to perform multicast tunneling between IPv6 networks through an IPv4 network. This makes a separate address translation table unnecessary, and reduces data transmission load, thereby increasing transmission efficiency.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 schematically illustrates a typical tunneling process from an IPv6 network to another IPv6 network through an IPv4 network;

FIG. 2 illustrates in more detail a typical tunneling process from an IPv6 network to another IPv6 network through an IPv4 network;

FIG. 3 illustrates a configuration for multicasting in a typical IPv6 network;

FIG. 4 illustrates an example of multicasting by IPv6-tunneling through an IPv4 network;

FIG. 5 is a block diagram of an automatic tunneling apparatus for multicasting between an IPv4 network and an IPv6 network according to a preferred embodiment of the present invention;

FIG. 6 illustrates an example of the structure of an IPv4 multicast table and an IPv6 multicast table;

FIG. 7 illustrates the structure of an IPv4 header;

FIG. 8 illustrates the structure of an IPv6 header;

FIG. 9 is a block diagram of an exemplary configuration for performing multicast tunneling between an IPv4 network and an IPv6 network using the IPv6/IPv4 router of FIG. 5; and

FIG. 10 is a flowchart illustrating a multicast tunneling method using a multicast tunneling apparatus between an IPv4 network and an IPv6 network according to a preferred embodiment of the present invention.

### DETAILED DESCRIPTION OF THE INVENTION

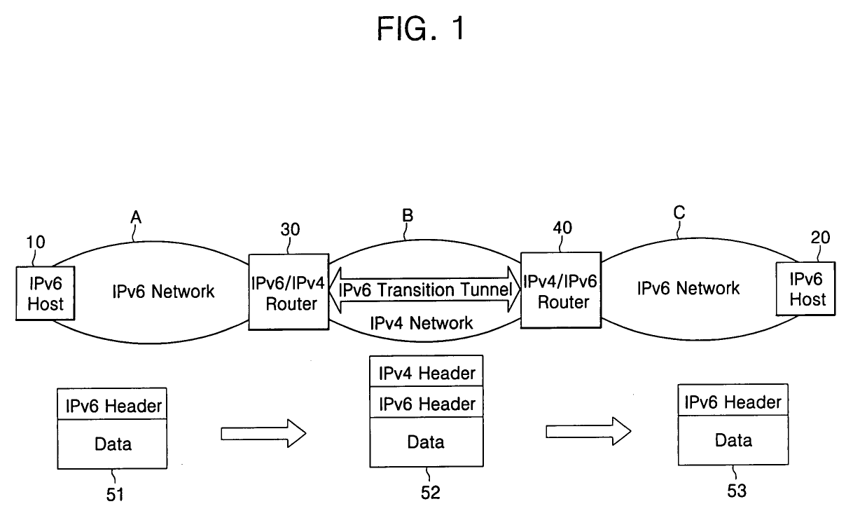

FIG. 1 schematically illustrates a typical tunneling process from an IPv6 network to another IPv6 network through an IPv4 network.

More specifically, FIG. 1 shows an example in which an IPv6 host 10 connected to an IPv6 network A transmits data to an IPv6 host 20 connected to another IPv6 network C, with an IPv4 network B being interposed between the two IPv6 networks A and B.

Referring to FIG. 1, the IPv6 host 10 transmits the IPv6-capsulated data 51 to the IPv6 network A. An IPv6/IPv4 router 30, which is located at an interface between the IPv6 network A and the IPv4 network B, capsulates the data 51 from IPv6 format to IPv4 format, and sends the IPv4-capsulated data to an IPv4/IPv6 router 40 located at an interface between the IPv4 network B and the IPv6 network C. That is, the IPv6/IPv4 router 30 adds an IPv4 header to the data 51, and then transmits the data 52 to the IPv4 network B.

The IPv4/IPv6 router 40 receives and decapsulates the IPv4-capsulated data 52, and transmits the data to the IPv6 network C. Specifically, the IPv4/IPv6 router 40 removes the IPv4 header, which was added so as to pass through IPv4 network B, and then transmits the data to the IPv6 network C. The IPv6 host 20 is then allowed to receive data 53 in IPv6 format with the IPv4 header removed.

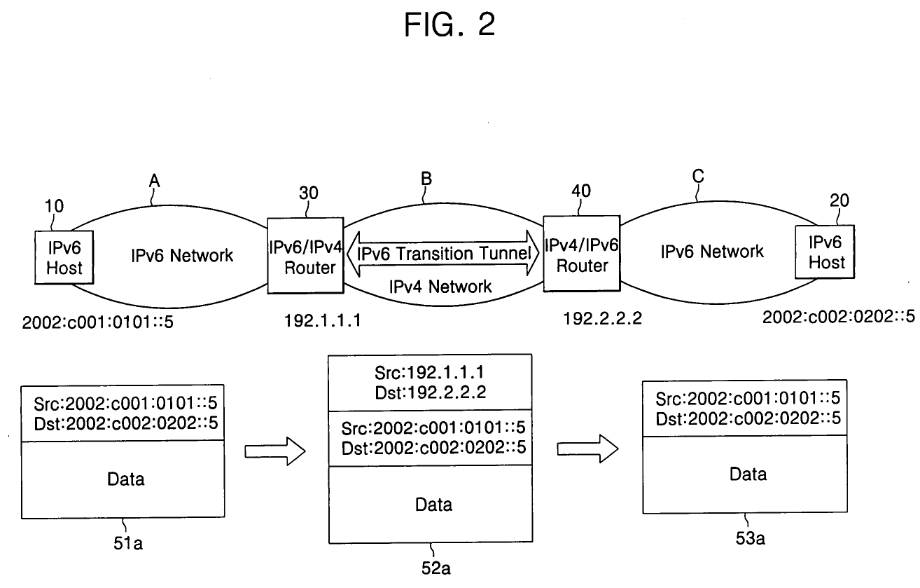

FIG. 2 illustrates in more detail a typical tunneling process from an IPv6 network to another IPv6 network through an IPv4 network.

Specifically, FIG. 2 shows an example in which the IPv6 host 10 of FIG. 1 has an IPv6 address of “2002:c001:0101::5” and the IPv6 host 20 of FIG. 1 has an IPv6 address of “2002:c002:0202::5”. That is, FIG. 2 illustrates a tunneling process in which the IPv6 host 10 having an IPv6 address of “2002:c001:0101::5” transmits the data to the IPv6 host 20 having the IPv6 address of “2002:c002:0202::5” through the IPv4 network B.

Further referring to FIG. 2, the IPv6 host 10 performs IPv6 capsulation by adding an IPv6 header to the data that will be transmitted. The IPv6 header contains an address of a source from which the data will be transmitted (hereinafter, referred to as “Src”) and an address of a destination to which the data will be transmitted (hereinafter, referred to as “Dst”). In the example of FIG. 2, since the source (Src) of the data to be transmitted corresponds to the IPv6 host 10 and the destination (Dst) corresponds to the IPv6 host 20, the IPv6 header of the IPv6-capsulated data 51a contains the address of the IPv6 host 10 (2002:c001:0101::5) and the address of the IPv6 host 20 (2002:c002:0202::5). The IPv6 host 10 transmits the IPv6-capsulated data 51a to the IPv6/IPv4 router 30 through the IPv6 network A.

The IPv6/IPv4 router 30 performs IPv4 capsulation by adding an IPv4 header to the data 51a. The IPv4 header is created based on information about the source and destination addresses contained in the IPv6 header of the data 51a. For example, the IPv4 header is created using IPv4 address information contained in the source and destination addresses in IPv6 format contained in the IPv6 header. The IPv4 address information is placed at second and third columns of the IPv6 address, wherein a value of the address is translated and utilized as a value in the decimal number system.

In the example of FIG. 2, since the source address of the data 51a is “2002:c001:0101::5”, the second and third column value c001:0101 is extracted from the source address and translated into a value in the decimal number system by two digits, obtaining “192.1.1.1”. Meanwhile, since the destination address of the data 51a is “2002:c002:0202::5”, the second and third column value c002:0202 is extracted from the destination address and translated into a value in the decimal number system by two digits, obtaining “192.2.2.2”. As a result, IPv4-capsulated data 52a contains an IPv4 header having the source address of “192.1.1.1” and the destination address of “192.2.2.2”.

The IPv6/IPv4 router 30 transmits the data 52a to the IPv4/IPv6 router 40 through the IPv4 network B based on the source and destination address information of the IPv4 header. That is, the IPv6/IPv4 router 30 transmits the IPv4-capsulated data 52a to the IPv4/IPv6 router 40, which is connected to the IPv6 network C including the IPv6 host 20 having the IPv6 address “192.2.2.2” of the destination.

The IPv4/IPv6 router 40 decapsulates and transmits the received data 52a to the IPv6 network C. That is, IPv4/IPv6 router 40 removes the IPv4 header from IPv4-capsulated data 52a, and then transmits the data to the IPv6 host 20 through IPv6 network C.

The IPv6 host 20 then receives the data 53a in IPv6 format with the IPv4 header removed.

Generally, tunneling from the IPv6 network A to the IPv6 network C through the IPv4 network B requires IPv4 capsulation using information about the IPv4 address contained in the IPv6 address. In other words, the IPv6 address should contain the IPv4 address in order to perform IPv4 capsulation.

However, data which is multicast over the IPv6 network A does not contain an IPv4 address in an IPv6 destination address, but rather contains only a pre-engaged multicast address (“ff02”). Thus, in IPv6-tunneling through an IPv4 network, IPv4-capsulation for the multicast data is impossible if the destination address is the multicast address (“ff02”). As a result,IPv6 protocol using the multicast address, (e.g., routing information protocol (RIP) ng, open shortest path first (OSPF) v3, protocol independent multicast-dense mode (PIM-DM), protocol independent multicast-sparse mode (PIM-SM), distance vector multicast routing protocol (DVMRP), resource reservation protocol (RSVP), etc.) is unavailable. In other words, the use of the IPv6-tunneling method through an IPv4 network in communicating data between an IPv6 network and an IPv4 network makes multicasting impossible.

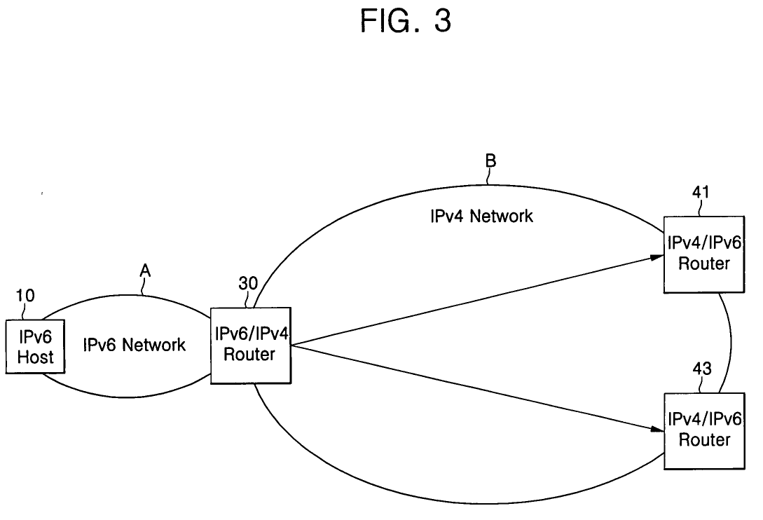

FIG. 3 illustrates a configuration for multicasting in a typical IPv6 network. Referring to FIG. 3, when an IPv6 host 10 connects to an IPv6 network A and desires to multicast data to a number of other IPv6 hosts connected to an IPv6 host 10 through an IPv4 network B, an IPv6/IPv4 router 30, located at an interface between the IPv6 network A and the IPv4 network B, should simultaneously transmit the multicast data from the IPv6 host 10 to an IPv4/IPv6 router 41 and an IPv4/IPv6 router 43. As stated above, however, the multicast data does not contain IPv4 addresses, i.e., does not contain IPv4 addresses of destination IPv6 hosts connected through the IPv4/IPv6 router 41 and the IPv4/IPv6 router 43. For this reason, the IPv6 host 10 is unable to perform multicasting by IPv6-tunneling through the IPv4 network as illustrated in FIGS. 1 and 2.

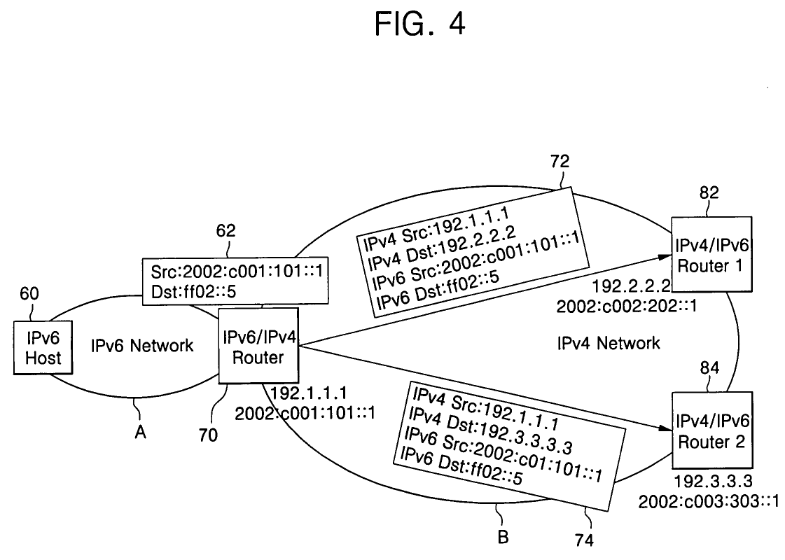

FIG. 4 illustrates an example of multicasting by IPv6-tunneling through an IPv4 network.

In FIG. 4, it is assumed that an IPv6/IPv4 router 70 has an IPv4 address table corresponding to a multicast address in order to perform multicasting through IPv4-tunneling to an IPv4/IPv6 router 1 82 and an IPv4/IPv6 router 2 84 in response to a request from an IPv6 host 60.

The IPv6 host 60 transmits a multicast packet, containing source and multicast destination addresses 62 in IPv6 format, to the IPv6/IPv4 router 70 over an IPv6 network A.

The IPv6/IPv4 router 70 translates and IPv4-capsulates the source and multicast addresses 62 in the multicast packet into IPv4-version source and destination addresses by referring to the IPv4 address table, and transmits data containing each address information to the IPv4/IPv6 router 1 82 and the IPv4/IPv6 router 284.

Although the multicasting is performed using IPv6 tunneling through the IPv4 network B as described above, the IPv6/IPv4 router 70 should duplicate and transmit the same data to each of the IPv4/IPv6 router 182 and the IPv4/IPv6 router 284. Thus, in the multicast method described above, the number of duplicates of the same data which must be made and transmitted equals the number of IPv6 networks at a destination to which the data is multicast. Accordingly, as the number of IPv6 networks at each destination address increases, so does data transmission load, thus degrading transmission efficiency.

The present invention will now be described more fully with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

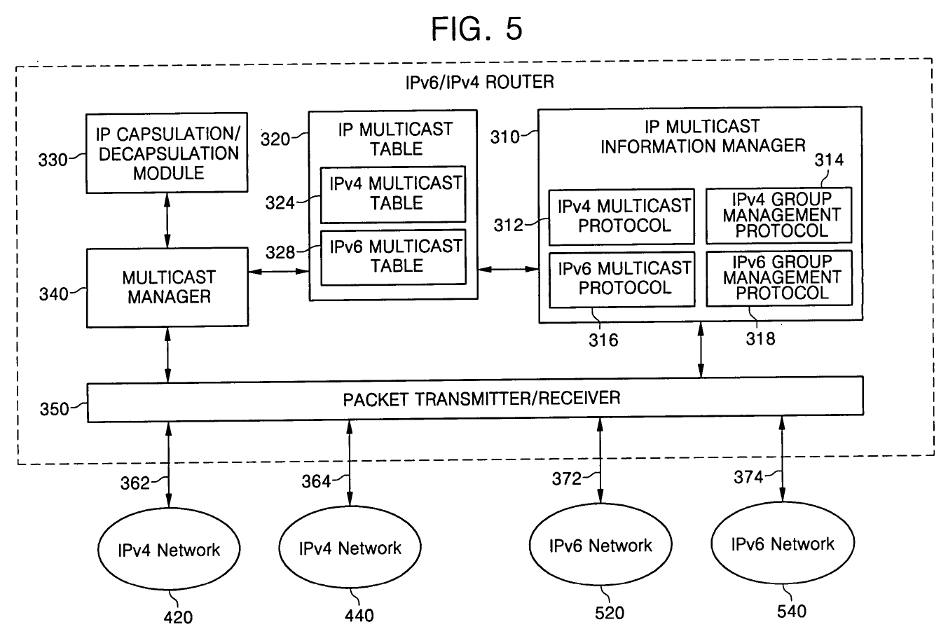

FIG. 5 is a block diagram of an automatic tunneling apparatus for multicasting between an IPv4 network and an IPv6 network according to a preferred embodiment of the present invention.

In the following description, an IPv4 multicast address is an address used as an IPv6 tunneling address in an IPv4 multicast network, and may be input by a manager or assigned as an authorized IP area. An IPv4 multicast address has a format of 224.10.0.0/16. An IPv6 multicast address is an address that is used as an automatic tunneling address in an IPv6 multicast network. It utilizes a prefix that allows an IPv4 multicast address area, and may be inputted by a manager or assigned as an authorized IP area. The IPv6 multicast address has a format of FF:8E::224.10.0.0/112.

In FIG. 5, the IPv4 network/IPv6 network multicast tunneling apparatus is an IPv6/IPv4 router provided between an IPv6 network and an IPv4 network. In the present invention, the IPv6/IPv4 router performs separate processing to receive a multicast packet since the IPv6 network and the IPv4 network form independent multicast delivery trees. However, routing protocols using, for example, DVMRP or PIM-DM do not require such separate processing. On the other hand, protocols such as the PIM-SM need joint message transmission to receive a multicast packet, wherein it is required to transmit a joint request message to a rendezvous point (RP), which is the root of a multicast delivery tree of an IPv6-IPv4 compatible address area.

For example, in the case where an IPv4 multicast address is 224.10.0.0/16 and an IPv6 multicast address is FF:8E::224.10.0.0/112:

(1) when the PIM-SM is used as a multicast routing protocol in the IPv4 network, an IPv6/IPv4 router transmits the joint request message to an RP of a group of 224.10.0.0/16; and

(2) when the PIM-SM is used as a multicast routing protocol in the IPv6 network, the IPv6/IPv4 router transmits the joint request message to an RP of a group of FF:8E::224.10.0.0/112.

An IP multicast information manager 310 manages multicast protocols and group management protocols for multicasting with respect to the IPv4 network and the IPv6 network, respectively. The IP multicast information manager 310 executes the IPv4 multicast protocol 312 and the IPv4 group management protocol 314 to form a multicast delivery tree of the IPv4 network, thus creating an IPv4 multicast table 324. The IP multicast information manager 310 also executes the IPv6 multicast protocol 316 and the IPv6 group management protocol 318 to form a multicast delivery tree of the IPv6 network, thus creating an IPv6 multicast table 328.

IPv4 multicast table 324 and IPv6 multicast table 328 may be logically configured to be one IP multicast table 320.

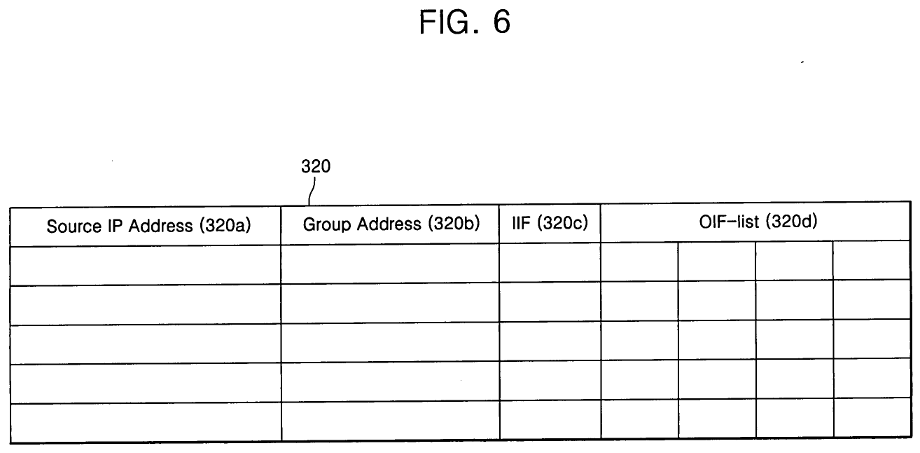

FIG. 6 illustrates an example of the structure of an IPv4 multicast table and an IPv6 multicast table. As shown in FIG. 6, the IP multicast table 320 for each network, which has an IPv4 multicast table 324 and an IPv6 multicast table 328, includes a source IP address 320a of a multicast packet, a group address 320b of the multicast packet having the source IP address 320a, a receive interface 320c of the multicast packet, and a transmit interface list 320d of the multicast packet.

For reference, the structures of the IPv4 header and the IPv6 header applied to the present invention will be briefly discussed.

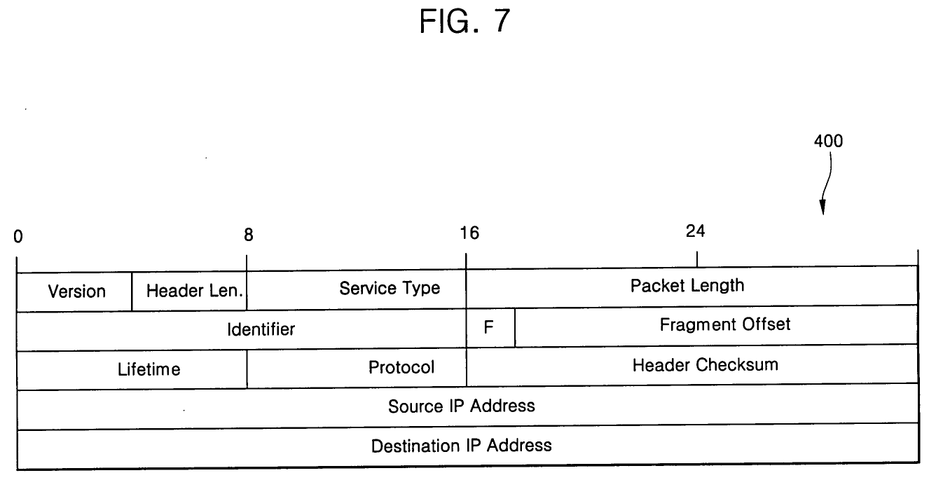

FIG. 7 illustrates the structure of an IPv4 header. As shown in FIG. 7, the IPv4 header 400 is composed of Version, Header Len.(or Length), Service Type, Packet Length, Identifier, F, Fragment Offset, Lifetime, Protocol, Header Checksum, Source IP address, and Destination IP address.

The Version is information about a version of the IP, the Header Len.(or Length) is information about a length of the IP header, the Service Type indicates quality of service requested by an IP datagram as transmitted, the Packet Length indicates a total length of the IP datagram, and the Identifier indicates an identifier created by a transmitting host and comprises identification information used to identify connection pieces of fragments. Furthermore, the F is used to control fragmentation of the datagram. The Fragment Offset is an offset of the fragmented IP datagram, the Lifetime indicates the number of networks through which the datagram is allowed to pass, the Protocol is protocol code information for identifying an upper level protocol of the IP, and the Header Checksum is error check information for error detection in an IP header field. The source IP address is IP address information of a source host that transmits packet data, and the destination IP address is IP address information of a destination I host that receives the packet data.

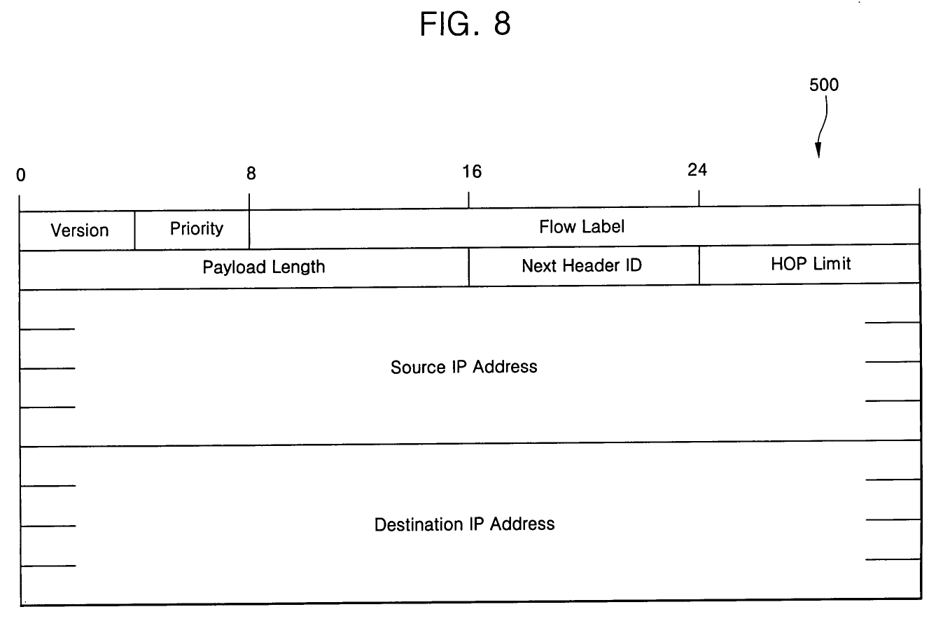

FIG. 8 illustrates the structure of an IPv6 header. As shown in FIG. 8, the IPv6 header 500 is composed of Version, Priority, Flow Label, Payload Length, Next Header ID, HOP Limit, Source IP address, and Destination IP address.

The Version is information about a version of the IP, the Priority indicates information about the class or priority of the IPv6 packet, and the Flow Label is information about a label of a data flow from a transmitting host to a receiving host and is used to provide a basic or higher quality service connection as in real-time data, (i.e., voice and image). The Payload Length is information about a length of an IP payload, the Next Header ID is protocol information of a first extension header or a protocol data unit (PDU) of an upper layer, and the HOP Limit indicates the maximum number of links over which an IPv6 packet is allowed to move.

An automatic tunneling process for multicasting according to the present invention will now be described with reference to FIGS. 5 thru 8.

First, the IP multicast information manager 310 receives an IPv4 multicast address area inputted by a manager. It is assumed in this embodiment that the IPv4 multicast address area is 224.10.0.0/16, an automatic compatible address area.

The IP multicast information manager 310 also receives an IPv6 multicast address area inputted by the manager. It is assumed in this embodiment that the IPv6 multicast address area is FF:8E::/96. The IP multicast information manager 310 adds 224.10.0.0/16 to FF:8E::/96 to thereby produce FF:8E::224.10.0.0/112 as a final IPv6 multicast address area since the lower 4 bytes of the IPv6 address are mapped to the IPv4 address.

When the multicast routing protocol of the IPv4 network is the PIM-SM, the IPv6/IPv4 router transmits a joint request signal to the RP of a group of 224.10.0.0/16. Furthermore, when the multicast routing protocol of the IPv6 network is the PIM-SM, the IPv6/IPv4 router transmits a joint request signal to the RP of a group of FF:8E::224.10.0.0/112.

The packet transmitter/receiver 350 transmits/receives data to/from IPv4 networks 420 and 440 and IPv6 networks 520 and 540. The multicast manager 340 sends the packet data via the packet transmitter/receiver 350 by referring to the IP multicast table 320. The IP capsulation/decapsulation module 330 capsulates and decapsulates the packet data.

When receiving the multicast packet transferred from the source IPv6 host to the group of FF8E::224.10.10.10 through the IPv6 network, the packet transmitter/receiver 350 provides the received multicast packet to the multicast manager 340.

The multicast manager 340 detects a source address and a group address of the source IPv6 host contained in the multicast packet. The multicast manager 340 also detects a set transmit interface corresponding to the detected source and group addresses by referring to the IPv6 multicast table 328. The multicast manager 340 then outputs the multicast packet to the detected transmit interface via the packet transmitter/receiver 350 so as to perform multicasting to the IPv6 network.

When the multicast packet received at the IPv6/IPv4 router is a packet requiring multicast tunneling toward a number of IPv6 networks connected to the IPv4 network, the IP capsulation/decapsulation module 330 capsulates the received multicast packet into the IPv4 packet if a group address of the received multicast packet belongs to FF:8E:224.10.0.0/112, which is a multicast automatic compatible address. The IPv4 destination IP address is 224.10.10.10, extracted from the destination IP address of IPv6 header, and the IPv4 source IP address is an IPv4 compatible region extracted from a source IP address of the IPv6 header. In other words, in order to IPv4-multicast the IPv6 multicast packet through the IPv4 network, the IP capsulation/decapsulation module 330 extracts a 4-byte area compatible with IPv4 from the IPv6 multicast address, and utilizes it as an IPv4 multicast address. For example, when the IPv6 multicast address is FF:8E:224.10.2.23, the IP capsulation/decapsulation module 330 extracts 224.10.2.23 from FF:8E:224.10.2.23, and utilizes it as an IPv4 multicast address.

The multicast manager 340 then detects the transmit interface by referring to the IPv4 multicast table 324 so as to transmit the IPv4-capsulated multicast packet from the IP capsulation/decapsulation module 330. The multicast manager 340 then outputs the IPv4-capsulated multicast packet to the detected transmit interface via the packet transmitter/receiver 350 so as to perform IPv4 network multicasting.

Meanwhile, when the IPv6/IPv4 router receives an IPv4 multicast packet containing a multicast automatic compatible address region (224.10.10.20 in this embodiment) from the IPv4 network, the packet transmitter/receiver 350 outputs the received IPv4 multicast packet to the multicast manager 340.

The multicast manager 340 recognizes that the destination address of the IPv4 packet is an IPv6 automatic compatible address, and outputs the IPv4 packet to the IP capsulation/decapsulation module 330. The IP capsulation/decapsulation module 330 removes the IPv4 header from the IPv4 packet, or performs decapsulation to extract an original IPv6 packet.

The multicast manager 340 detects the transmit interface for the decapsulated IPv6 multicast packet by referring to the IPv6 multicast table 328. The multicast manager 340 then outputs the IPv6 multicast packet to the detected transmit interface via the packet transmitter/receiver 350 so as to perform IPv6 network multicasting.

In the present invention, an IPv6 multicast address compatible with an IPv4 multicast address is utilized. The IPv4 multicast address is extracted from the IPv6 multicast address to capsulate the IPv6 multicast packet into an IPv4 multicast packet, and then perform multicast tunneling between IPv6 networks through an IPv4 network. This makes a separate address translation table unnecessary, and reduces data transmission load, thereby increasing transmission efficiency.

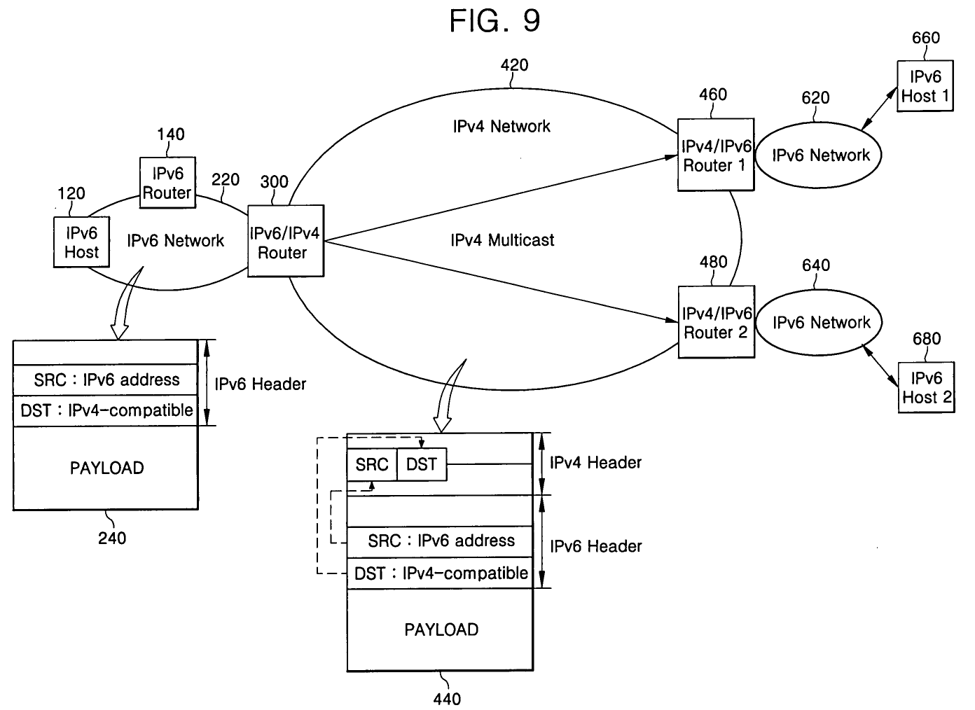

FIG. 9 is a block diagram of an exemplary configuration for performing multicast tunneling between an IPv4 network and an IPv6 network using the IPv6/IPv4 router of FIG. 5.

An IPv6 host 120 transmits an IPv6 multicast packet to an IPv6/IPv4 router 300 through an IPv6 network 220 in order to forward the multicast packet to an IPv6 host 1 660 and an IPv6 host 2 680. Source and destination addresses in the address information contained in a header 240 of the IPv6 multicast packet are IPv6-format addresses compatible with IPv4.

Upon receipt of the IPv6 multicast packet, the IPv6/IPv4 router 300 extracts an IPv4 compatible region from the source address in IPv6 format contained in the header of the IPv6 multicast packet, and utilizes it as an IPv4 source address. The IPv6/IPv4 router 300 also extracts 4 bytes as an IPv4 compatible region from the source address in IPv6 format contained in the header of the IPv6 multicast packet, and utilizes it as an IPv4 multicast address.

The IPv6/IPv4 router 300 also extracts the source and destination addresses in IPv4 format from the source and destination addresses in IPv6 format extracted from the IPv6 header, and performs IPv4 capsulation. The IPv6/IPv4 router 300 IPv4-multicasts an IPv4-capsulated header 440 to an IPv4/IPv6 router 1 460 and an IPv4/IPv6 router 2 480 through an IPv4 network 420.

The IPv4/IPv6 router 1 460 and the IPv4/IPv6 router 2 480 remove the IPv4 header from the IPv4 multicast packet, which is IPv4-multicast by and received from the IPv6/IPv4 router 300 through the IPv4 network 420, and extracts the IPv6 multicast packet. The IPv4/IPv6 router 1 460 and the IPv4/IPv6 router 2 480 then transmit the extracted IPv6 multicast packet to IPv6 hosts 1 and 2 660 and 680 through the IPv6 networks 620 and 640, respectively.

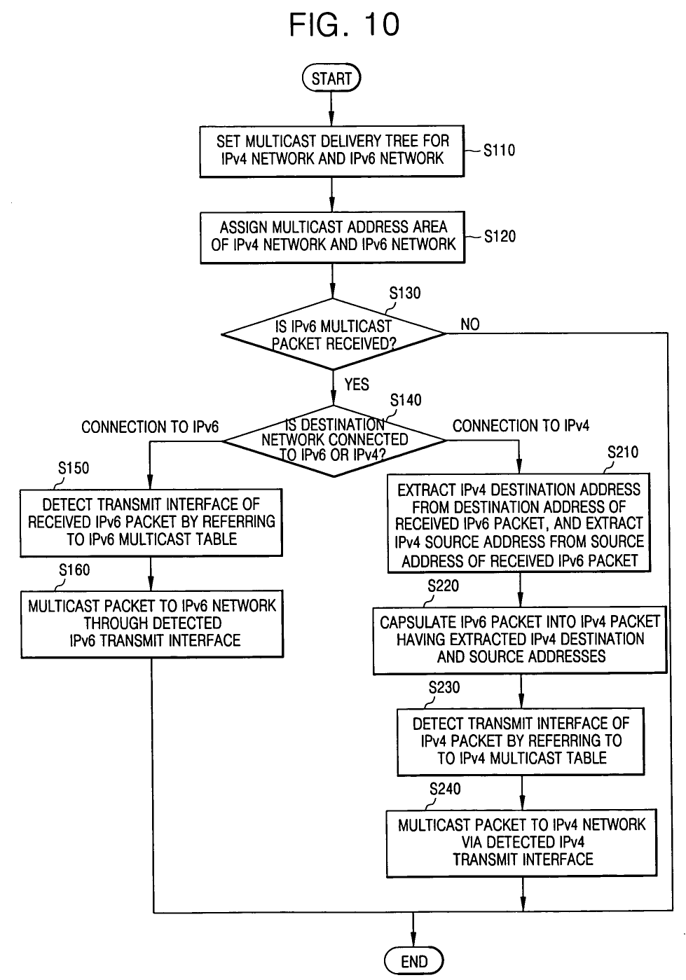

FIG. 10 is a flowchart illustrating a multicast tunneling method using a multicast tunneling apparatus between an IPv4 network and an IPv6 network according to a preferred embodiment of the present invention.

First, the IPv6/IPv4 router 300 sets the IPv4 multicast table 324, which is a multicast delivery tree of the IPv4 network, using an IPv4 multicast protocol and an IPv4 group management protocol, and sets the IPv6 multicast table 328, which is a multicast delivery tree of the IPv6 network, using an IPv6 multicast protocol and an IPv6 group management protocol (S110).

The IPv6/IPv4 router 300 receives, from the manager, and assigns a multicast address area of the IPv4 network and a multicast address area of the IPv6 network compatible with IPv4 (S120).

The IPv6/IPv4 router 300 determines whether it has received the IPv6 multicast packet from the IPv6 host (S130). If the IPv6 multicast packet is determined to have been received, the IPv6/IPv4 router 300 determines the connection type of the network to which the network at the destination address of the IPv6 multicast packet is connected (S140).

If the network at the destination address of the IPv6 multicast packet is determined to be connected to the IPv6 network 220, the IPv6/IPv4 router 300 detects a transmit interface of the received IPv6 multicast packet by referring to the IPv6 multicast table 328 (S150). The IPv6/IPv4 router 300 then IPv6-multicasts the multicast packet to an IPv6 router 140 in the IPv6 network 220 via the detected IPv6 transmit interface (S160).

Conversely, if the network at the destination address of the IPv6 multicast packet is determined in S140 to be connected to IPv4 network 420, the IPv6/IPv4 router 300 extracts the IPv4 multicast destination address from the IPv6 multicast destination address of the received IPv6 multicast packet, and extracts the IPv4 source address from the source address of the IPv6 multicast packet (S210). The IPv6/IPv4 router 300 the capsulates the IPv6 multicast packet into the IPv4 multicast packet, which contains the extracted IPv4 multicast destination address and IPv6 source address (S220). The IPv6/IPv4 router 300 then detects a transmit interface of the capsulated IPv4 multicast packet by referring to the IPv4 multicast table 324 (S230). Finally, the IPv6/IPv4 router 300 multicasts the IPv4 multicast packet to the IPv4/IPv6 router 1 460 and the IPv4/IPv6 router 2 480 of the IPv4 network 420 via the detected IPv4 transmit interface (S240).

In the present invention, an IPv6 multicast address compatible with an IPv4 multicast address is utilized. The IPv4 multicast address is extracted from the IPv6 multicast address so as to capsulate an IPv6 multicast packet into an IPv4 multicast packet, and then perform multicast tunneling between IPv6 networks through an IPv4 network. This makes provision of a separate address translation table unnecessary, and reduces the data transmission load, thereby increasing transmission efficiency.

While the present invention has been described with reference to exemplary embodiments thereof, it will be apparent to those of skill in the art that various changes may be made to the described embodiments without departing from the spirit and scope of the present invention as defined by the appended claims and their equivalents.

What is claimed is:

1. A tunneling method for multicasting between different types of networks having different address formats, said method comprising the steps of:
setting a multicast table containing information about receive and transmit interfaces in a multicast delivery tree structure for each of a first network having a first address format and a second network having a second address format, the second address format being different from the first address format;
assigning a multicast address area to the first network and a multicast address area to the second network compatible with the first network;
receiving a second network multicast packet containing source and multicast destination addresses in the second address format; and
when a destination network of the second network multicast packet is the second network connected to the first network, extracting source and multicast destination addresses in the first address format from the source and multicast destination addresses in the second address format, and multicast-tunneling the second network multicast packet to the second network through the first network by referring to the multicast table.

2. The method according to claim 1, wherein the step of multicast-tunneling comprises:
capsulating the second network multicast packet into a first network multicast packet containing the extracted source and multicast destination addresses in the first address format to form a first capsulated network multicast packet;
detecting, from the multicast table, a first network transmit interface for the first capsulated network multicast packet; and
multicast-tunneling the first capsulated network multicast packet to the first network using the detected first network transmit interface.

3. The method according to claim 1, further comprising the steps of:
detecting, from the multicast table, a second network transmit interface for the second network multicast packet when a destination network of the second network multicast packet is the second network; and
multicasting the second network multicast packet to the second network using the detected second network transmit interface.

4. A tunneling method for multicasting between an IPv4 network and an IPv6 network, said method comprising the steps of:
setting a multicast table containing information about receive and transmit interfaces in a multicast delivery tree structure for each of the IPv4 network and the IPv6 network;
assigning a multicast address area to the IPv4 network and a multicast address area to the IPv6 network compatible with IPv4 network;
receiving an IPv6 multicast packet containing source and multicast destination addresses of the IPv6 network; and
when a destination network of the IPv6 multicast packet is the IPv6 network connected to the IPv4 network, extracting source and multicast destination addresses of the IPv4 network from the source and multicast destination addresses contained in the IPv6 multicast packet, capsulating the IPv6 multicast packet into an IPv4 format to form an IPv4 format packet, and multicast-tunneling the IPv4 format packet to the IPv6 network through the IPv4 network by referring to the multicast table.

5. The method according to claim 4, wherein the step of multicast-tunneling comprises:
capsulating the IPv6 multicast packet into an IPv4 multicast packet containing the extracted source and multicast destination addresses of the IPv4 network to form a capsulated IPv4 multicast packet;
detecting, from the multicast table, an IPv4 network transmit interface for the capsulated IPv4 multicast packet; and
multicast-tunneling the capsulated IPv4 multicast packet to the IPv4 network using the detected IPv4 network transmit interface.

6. The method according to claim 4, further comprising the steps of:
detecting, from the multicast table, an IPv6 transmit interface for the IPv6 multicast packet when a destination network of the IPv6 network multicast packet is the IPv6 network; and
multicasting the IPv6 multicast packet to the IPv6 network using the detected IPv6 transmit interface.

7. A tunneling apparatus for multicasting between networks having different address formats, said apparatus comprising:
a packet transmitter/receiver connected to a first network having a first address format and to a second network having a second address format for receiving and transmitting a packet, the second address format being different from the first address format;
a multicast information manager for setting a multicast table containing information about receive and transmit interfaces in a multicast delivery tree structure for each of the first network and the second network;
a capsulator/decapsulator for capsulating a packet received from the second network into a packet for the first network, and for decapsulating a packet received from the first network into a packet for the second network; and
a multicast manager for assigning a multicast address area to the first network and a multicast address area to the second network compatible with the first network, for extracting source and multicast destination addresses in the first address format from source and multicast destination addresses in the second address format contained in a second network multicast packet for multicast-tunneling through the first network to the second network, and for multicast-tunneling the second network multicast packet to the second network through the first network by referring to the multicast table.

8. The apparatus according to claim 7, wherein the capsulator/decapsulator capsulates the second network multicast packet into a multicast packet for the first network to form a first capsulated network multicast packet containing the extracted source and multicast destination addresses in the first address format, and
the multicast manager detects, from the multicast table, a first network transmit interface for the first capsulated network multicast packet, and multicast-tunnels the first capsulated network multicast packet to the first network using the detected first network transmit interface.

9. The apparatus according to claim 7, wherein the multicast manager detects, from the multicast table, a second network transmit interface for the second network multicast packet, and multicasts the second network multicast packet to the second network using the detected second network transmit interface when a destination network of the second network multicast packet is the second network.

10. A tunneling apparatus for multicasting between an IPv4 network and an IPv6 network, said apparatus comprising:
a packet transmitter/receiver connected to the IPv4 network and to the IPv6 network for receiving and transmitting a packet;
a multicast information manager for setting a multicast table containing information about receive and transmit interfaces in a multicast delivery tree structure for each of the IPv4 network and the IPv6 network;
a capsulator/decapsulator for capsulating a packet in an IPv6 network format into a packet in an IPv4 network format, and for decapsulating the capsulated packet in the IPv4 network format into the packet in the IPv6 network format; and
a multicast manager for assigning a multicast address area to the IPv4 network and a multicast address area to the IPv6 network compatible with IPv4 network, for extracting source and multicast destination addresses in an IPv4 address format from source and multicast destination addresses in an IPv6 address format contained in an IPv6 multicast packet for multicast-tunneling through the IPv4 network to the IPv6 network, and for multicast-tunneling the IPv6 network multicast packet to the IPv6 network through the IPv4 network by referring to the multicast table.

11. The apparatus according to claim 10, wherein the capsulator/decapsulator capsulates the IPv6 multicast packet into an IPv4 multicast packet containing the extracted source and multicast destination addresses in the IPv4 address format to form a capsulated IPv4 network multicast packet, and
wherein the multicast manager detects, from the multicast table, an IPv4 network transmit interface for the capsulated IPv4 network multicast packet, and multicast-tunnels the capsulated IPv4 network multicast packet to the IPv4 network using the detected IPv4 network transmit interface.

12. The apparatus according to claim 10, wherein the multicast manager detects, from the multicast table, an IPv4 network transmit interface for the IPv6 multicast packet, and multicasts the IPv6 multicast packet to the IPv6 network using the detected IPv6 network transmit interface when a destination network of the IPv6 multicast packet is the IPv6 network.
